(19) United States
(12) Patent Application Publication
(10) Pub. No.: US 2008/0284593 A1
(43) Pub. Date: Nov. 20, 2008

(54) Method and system for power management of electronic article surveillance systems

(75) Inventors: Manuel A. Soto, Lake Worth, FL (US); Adam S. Bergman, Boca Raton, FL (US); John A. Allen, Pompano Beach, FL (US)

Correspondence Address: Christopher & Weisberg, P.A., 200 East Las Olas Boulevard, Suite 2040, Fort Lauderdale, FL, 33301, US

(73) Assignee: Sensormatic Electronics Corporation

(21) Appl. No.: 11/804,124

(22) Filed: May 17, 2007

(51) Int. Cl. G08B 13/00

(52) U.S. Cl. 340/541

(57) ABSTRACT

A method, system and apparatus for managing power use in security systems, which include establishing a detection region, triggering a person detection event, the person detection event based on the detection of a person in the detection region, starting a timer upon triggering the person detection event, and transmitting a tag interrogation signal until the expiration of the timer. The method, system and apparatus can further include determining a relative direction of movement of the person.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention generally relates to electronic security systems, and in particular, to an improved system and method for power management of electronic article surveillance (“EAS”) systems.

### BACKGROUND OF THE INVENTION

Electronic article surveillance (“EAS”) systems are detection systems that allow the identification of a marker or tag within a given detection region. EAS systems have many uses, but most often they are used as security systems for preventing shoplifting in stores or removal of property in office buildings. EAS systems come in many different forms and make use of a number of different technologies.

A typical EAS system includes an electronic detection unit, tags and/or markers, and a detacher or deactivator. The detection units can, for example, be formed as pedestal units, buried under floors, mounted on walls, or hung from ceilings. The detection units are usually placed in high traffic areas, such as entrances and exits of stores or office buildings. The tags and/or markers have special characteristics and are specifically designed to be affixed to or embedded in merchandise or other objects sought to be protected. When an active tag passes through a tag detection region, the EAS system sounds an alarm, a light is activated and/or some other suitable alert devices are activated to indicate the removal of the tag from the prescribed area.

Common EAS systems operate with these same general principles using either transceivers, which each transmit and receive, or a separate transmitter and receiver. Typically the transmitter is placed on one side of the detection region and the receiver is placed on the opposite side of the detection region. The transmitter produces a predetermined excitation signal in a tag detection region. In the case of a retail store, this detection region is usually formed at an exit. When an EAS tag enters the detection region, the tag has a characteristic response to the excitation signal, which can be detected. For example, the tag may respond to the signal sent by the transmitter by using a simple semiconductor junction, a tuned circuit composed of an inductor and capacitor, soft magnetic strips or wires, or vibrating magneto acoustic resonators. The receiver subsequently detects this characteristic response. By design, the characteristic response of the tag is distinctive and not likely to be created by natural circumstances.

An important consideration in connection with the use of such EAS systems is to minimize the power usage of the EAS detection units. Once powered on, current EAS systems operate continuously to create and monitor detection regions or zones. Since the power required to transmit interrogation signals is large compared with the power consumption of other parts of an EAS system, significant power reductions can be realized by deploying a smart EAS system that manages the amount of time that the transmitters operate.

What is needed is a method and system that can be used to reduce power consumption of EAS systems, particularly by managing transmitter power consumption.

### SUMMARY OF THE INVENTION

In accordance with one aspect, the present invention advantageously provides a method for power management in a security system, which method for power management includes establishing a detection region, triggering a person detection event that is based on the detection of a person in the detection region, starting a timer upon triggering the person detection event, and transmitting a tag interrogation signal until the expiration of the timer. The method can further include determining a relative direction of movement of the person.

In accordance with another aspect, the present invention provides a system for power management in a security system, which system for power management includes a transmitter for producing an applied field in a selected region, a sensor for detecting a person passing through the selected region, and a processor, which operates to trigger a person detection event that is based on the detection of a person in the detection region, to start a timer upon detecting the person detection event, and to transmit a tag interrogation signal until the expiration of the timer.

In accordance with another aspect, the present invention provides a computer program product that includes a computer usable medium having a computer readable program for power management in a security system, which when executed on a computer causes the computer to perform a method that includes establishing a detection region, triggering a person detection event that is based on the detection of a person in the detection region, starting a timer upon triggering the person detection event, and transmitting a tag interrogation signal until the expiration of the timer.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an electronic article surveillance system constructed in accordance with the principles of the present invention;

FIG. 2 is a diagram of an embodiment of an EAS detection unit of the electronic article surveillance system of FIG. 1, constructed in accordance with the principles of the present invention;

FIG. 3 is a diagram of a controller of an EAS detection unit of the electronic article surveillance system of FIG. 1, constructed in accordance with the principles of the present invention;

FIG. 4 is a diagram of an alternate embodiment of a controller of an EAS detection unit of the electronic article surveillance system of FIG. 1, constructed in accordance with the principles of the present invention; and

FIG. 5 is a detailed flowchart of an exemplary power management process in accordance with the principles of the present invention.

### DETAILED DESCRIPTION OF THE INVENTION

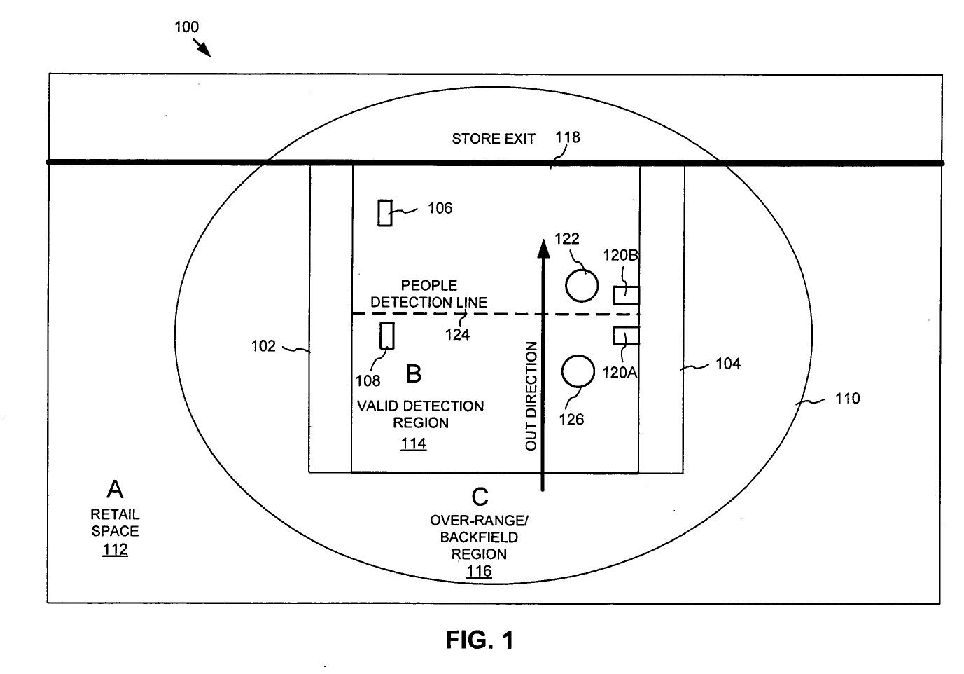

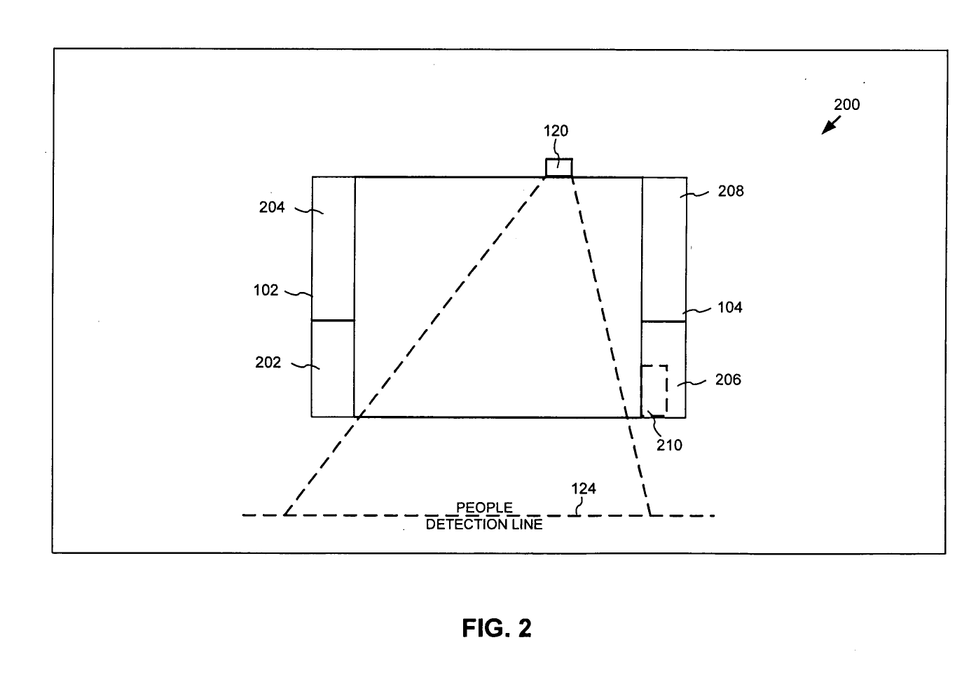

Referring now to the drawing figures in which like reference designators refer to like elements, there is shown in FIG. 1 a diagram of an exemplary system constructed in accordance with the principles of the present invention and designated generally as “100”. Electronic article surveillance (“EAS”) system 100 includes EAS detection units 102, 104 positioned generally in parallel and at a spaced distance from one another. EAS detection unit 102 can include a transmitter 202 (FIG. 2) and a transmitting antenna 204 (FIG. 2) for producing the electromagnetic fields that are used in conjunction with such systems to detect the presence of a tag, such as tags 106 and 108 affixed to merchandise to be protected. The other EAS detection unit 104 includes a receiver 206 (FIG. 2) and a receiving antenna 208 (FIG. 2), which then operate to detect a disturbance (resulting from the presence of an active tag 106) in the electromagnetic fields produced by the EAS detection unit 102. Detection of an active tag 106, 108 can result in the triggering of an appropriate alarm. EAS system 100 can create a detection region 110 in retail space 112. Detection region 110 can include valid alarm region 114 and over-range or backfield region 116. A store exit 118 also can be located within detection region 110.

Additionally, one of the EAS detection units 102, 104, preferably the EAS detection unit 104 that includes receiver 206 (FIG. 2), provides a sensor system 120 that includes sensors 120A, 120B (collectively referred to herein as sensor system 120 as used herein) that is capable of detecting the presence of someone exiting or entering the store between the EAS detection units 102, 104 of the EAS system 100. The sensor system 120 is capable of detecting the relative direction of a person's movement as that person enters or exits the store. A variety of people detection technologies such as sensors that provide a beam can be used for this purpose, e.g., infrared beam sensors, or other people detection sensors such as photoelectric sensors, body heat sensors, and even floor switches, as desired. These sensors can be deployed at various locations of EAS system 100. For example, sensor system 120 can be deployed in EAS detection units 102, 104, building posts, door frames and ceilings. Whatever the specific method of implementation, the sensor system 120 is electrically connected to the receiver 206 (FIG. 2) of the EAS system 100 so that the EAS system 100 can be informed when a person 122, e.g., a shopper, passes between the EAS detection units 102, 104 and crosses a people detection line 124 in detection region 110 in an “out” direction or an “in” direction.

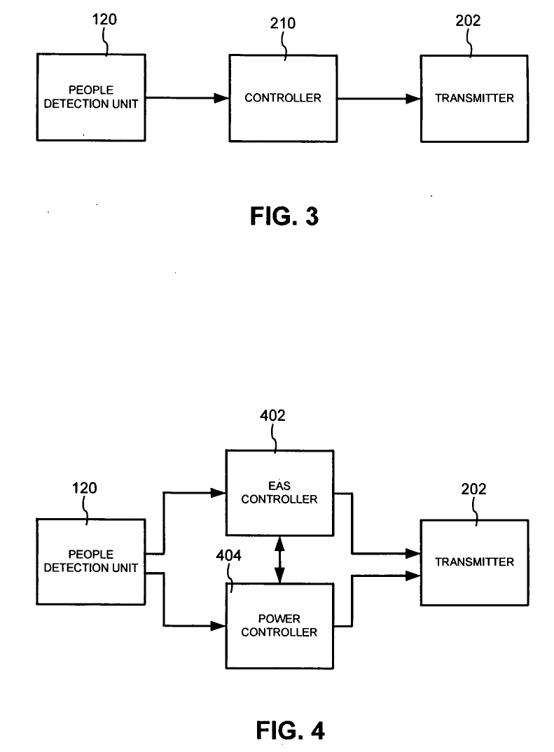

In FIG. 1, person 122 is shown located in valid detection region 114 at a point past the people detection line 124 while person 126 is shown located in valid detection region 114 at a point prior to the people detection line 124. In operation, as discussed in more detail with reference to FIGS. 3 and 4 below, person 122 causes a people detection event, which in this case is a “people detection out” event because person 122 has crossed detection line 124 in the out direction. On the other hand, person 126 does not generate a people detection event because person 126 has not crossed detection line 124. However, if person 126 has crossed the detection line 124 in the “in” direction, person 126 causes a people detection event which in this case is a “people detection in” event. This advantageously provides a user of EAS system 100 with the ability to configure system 100 so as to choose which conditions can cause a people detection event, and thereby cause the activation of the EAS transmitter 202. For example, when the EAS system 100 user, e.g., a retail store operator, does not want the activation of the EAS transmitter when a person 126 crosses people detection line 124 in the “in” direction, the user may define the crossing of detection line 124 in the “in” direction, as a non-detection event. In other words, the crossing of people detection line 124 in the “in” direction is not in a transmission enablement direction.

In another embodiment, a single EAS detection unit 102 is supplied that uses a transceiver 202 (FIG. 2) and a transceiver antenna 204 (FIG. 2) to establish detection region 110 by producing the electromagnetic fields that are used to detect the presence of tags, such as tags 106 and 108, affixed to merchandise to be protected. In this embodiment, transceiver 202 and transceiver antenna 204 also function to receive a disturbance in the produced electromagnetic field of EAS detection unit 102. For example, although FIG. 2 shows EAS detection unit 102 deployed in a pedestal, the transceiver 202 and/or the transceiver antenna 204 or both can be deployed on a door that is located at a store exit 118. In this embodiment, transceiver antenna 204 radiates the appropriate electromagnetic or radio frequency field to produce the detection region 110.

The processing of data and signals developed by the EAS detection units 102, 104 of the EAS system 100, as well as interaction with the sensor system 120, is accomplished by a controller 210 associated with the EAS system 100, that can be generally positioned within the transceivers/receivers 202, 206. In certain embodiments, the controller 210 executes one or more processes associated with EAS applications. FIG. 3 illustrates an embodiment of controller 210 of EAS detection units 102, 104. In this embodiment, the controller 210 is used to analyze detection data generated by the sensor system 120 and signals received by the receiver 206 to determine the presence of a tag 106 between the EAS detection units 102, 104 of the EAS system 100. The controller 210 executes instructions and manipulates data to perform the operations of EAS system 100 and may be, for example, a central processing unit (“CPU”), an application specific integrated circuit (“ASIC”) or a field-programmable gate array (“FPGA”). The controller 210 also controls the activation or enablement of the transmitters, e.g., transmitter 202, for all the various configurations of EAS system 100.

The controller 210 also controls various registers and counters such as people detection event registers and transmit timers, e.g., “TX_ON_Timer”, each of which relates to the operation of EAS system 100. These registers and timers can be located in controller 210 or in other memory of EAS system 100 that is in communication with controller 210. Although FIG. 2 illustrates a single controller 210 in EAS system 100, multiple controllers 210 may be used according to particular implementation needs, and reference to controller 210 is meant to include multiple controllers 210 where applicable. In this embodiment, transmitter 202 remains in a deactivated state, until it receives the transmit enable command signal from the controller 210.

FIG. 4 illustrates an alternate design of the controller 210 of EAS detection units 102, 104 of the EAS system 100. In this embodiment, an EAS system controller 402 can perform EAS system operations, such as processing the signals received by the receiver 206 to determine the presence of a tag 106 between the EAS detection units 102, 104 of the EAS system 100. However, as illustrated, a separate power controller 404 controls the activation or enablement of the transmitters, e.g., transmitter 202. In this embodiment, the power controller 404 controls the various registers and counters such as people detection event registers and transmit timers, e.g., “TX_ON_Timer”, each of which relates to the operation of the transmitters 202 of EAS system 100. In this embodiment, transmitter 202 remains in a deactivated state, until it receives the transmit enable command signal from the power controller 404.

Referring again to FIG. 2, a motion detector or people sensor 120 is illustrated mounted near the top of a store exit/entrance that is defined by EAS units 102, 104 that are integrated into two pillars or support columns. In this embodiment, sensor 120 is an infrared beam sensor, which defines the people detection line 124. People detection line 124 serves as an event trigger point to notify controller 210 to produce a people detection event when a person crosses the people detection line 124. The present invention further provides a means to determine the movement of people 122, 126 within detection region 110 via sensor system 120. For example, multiple sensors, e.g., 120A and 120B, of sensor system 120 can create one or more people detection lines or points 124. As a person or object crosses each detection line, an event signal is generated and processed by the controller 210 to determine the relative direction of the person.

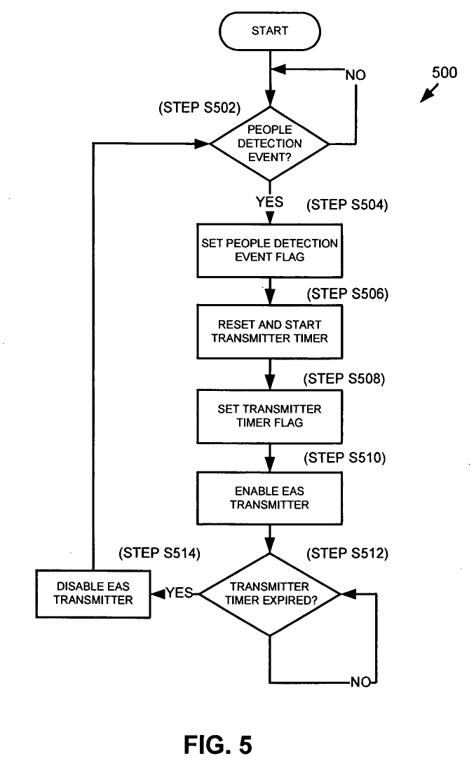

FIG. 5 is a flow chart illustrating an exemplary method 500 for power management of EAS system 100 using a sensor system 120. Exemplary method 500 is discussed with reference to EAS system 100, however, any other suitable system or portion of a system may use appropriate embodiments of method 500 to retrieve and process EAS information to manage the power consumption of EAS detection units 102, 104 in EAS detection region 110. Generally, method 500 describes a person 126 entering a detection region 110 and passing through a people detection line or point 124 to enable a transmitter 202 to transmit communication signals, e.g., interrogation signals, for a predetermined amount of time, such as the duration of a transmitter timer.

Exemplary method 500 begins at step S502, where a determination is made as to whether a people detection event has occurred, such as when a person 122 passes or crosses a people detection line or point 124. A people detection event can be defined to include all occurrences in which a person passes or crosses a people detection line or point 124, or it can be limited to include only those cases where the crossing of the people detection line 124 occurs in a certain direction, e.g., the “out” direction. In the illustrative example of FIG. 1, persons 122, 126 are shown in a valid detection region 114 of detection region 110. However, person 126 is shown located prior to the people detection line 124, while person 122 is shown having crossed the people detection line 124 in the “out” direction. In this example, person 122 causes a people detection event to occur which causes a people detection event flag to be set at step S504. If no people detection event is detected, then step S502 is repeated until a people detection event occurs.

At step S506, the people detection event causes a transmitter timer to be reset or cleared and then started. Next, a transmitter timer flag can be set at step S508. At step S510, a transmitter, e.g., transmitter 202, is enabled or activated to transmit or radiates the appropriate electromagnetic or radio frequency field to produce the detection region 110. If the transmitter timer has expired, the transmitter is disabled (step S514), and the process returns to step S502 to wait for the next people detection event. Otherwise, if the transmitter timer has not expired, the transmitter remains enabled and continues to transmit its appropriate electromagnetic or radio frequency field.

Transmitter timer is a timer that provides a time period for transmitter operation that can be predetermined and defined by the EAS system user.

The present invention advantageously provides and defines a comprehensive system and method for managing power consumption in an EAS system using people detection technologies such as infrared beam sensors.

The present invention can be realized in hardware, software, or a combination of hardware and software. An implementation of the method and system of the present invention can be realized in a centralized fashion in one computing system or in a distributed fashion where different elements are spread across several interconnected computing systems. Any kind of computing system, or other apparatus adapted for carrying out the methods described herein, is suited to perform the functions described herein.

A typical combination of hardware and software could be a specialized or general-purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

It will be appreciated by persons skilled in the art that the present invention is not limited to what has been particularly shown and described herein above. A variety of modifications and variations are possible in light of the above teachings without departing from the spirit or essential attributes thereof, and accordingly, reference should be had to the following claims, rather than to the foregoing specification, as indicating the scope of the of the invention.

What is claimed is:

1. A method for managing power use in a security system, the method comprising:
establishing a detection region;
triggering a person detection event, the person detection event based on the detection of a person in the detection region;
starting a timer upon the triggering of the person detection event; and
transmitting a tag interrogation signal until the expiration of the timer.

2. The method of claim 1, further comprising determining a relative direction of movement of the person.

3. The method of claim 2, wherein the person detection event is triggered if the relative direction is in a transmission enablement direction.

4. The method of claim 1, further comprising setting a people detection event flag upon triggering the people detection event.

5. The method of claim 1, further comprising setting a transmitter timer flag upon triggering the people detection event.

6. The method of claim 1, wherein the people detection event includes detecting a person crossing a people detection line in the detection region.

7. The method of claim 6, wherein the people detection line is generated using a people detection sensor.

8. The method of claim 7, wherein the people detection sensor is an infrared beam sensor.

9. The method of claim 1, further comprising setting the timer to a predetermined amount of time.

10. A system for managing power use in a security system, the system comprising:
a transmitter for producing an applied field in a selected region;
a sensor for detecting a person passing through the selected region; and
a processor, the processor operating to:
trigger a person detection event, the person detection event based on the detection of a person in the detection region;
start a timer upon triggering the person detection event; and
transmit a tag interrogation signal until the expiration of the timer.

11. The system of claim 10, wherein the processor further operates to determine a relative direction of movement of the person.

12. The system of claim 11, wherein the person detection event is triggered if the relative direction is in a transmission enablement direction.

13. The system of claim 10, wherein the processor further operates to set a people detection event flag upon triggering the people detection event.

14. The system of claim 10, wherein the processor further operates to set a transmitter timer flag upon triggering the people detection event.

15. The system of claim 10, wherein the people detection event includes detecting a person crossing a people detection line in the detection region.

16. The system of claim 15, wherein the people detection line is generated using a people detection sensor.

17. A computer program product comprising a computer usable medium having a computer readable program for a security system which when executed on a computer causes the computer to perform a method comprising:
establishing a detection region;
triggering a person detection event, the person detection event based on the detection of a person in the detection region;
starting a timer upon detecting the person detection event; and
enabling a transmitter until the expiration of the timer.

18. The method of claim 17, further comprising determining a relative direction of movement of the person.

19. The method of claim 18, wherein the person detection event is triggered if the relative direction is in a transmission enablement direction.

20. The method of claim 17, further comprising setting the timer to a predetermined amount of time.
